(19) United States
(12) Patent Application Publication
(10) Pub. No.: US 2005/0248098 A1
(43) Pub. Date: Nov. 10, 2005

(54) Gasket for a coupler upon a rail car, tank trailer, or related means

(76) Inventors: David E. Sisk, Bonne Terre, MO (US); Roger Breakfield, Potosi, MO (US)

Correspondence Address: Paul M. Denk;Ste. 170, 763 S. New Ballas Road, St. Louis, MO, 63141, US

(21) Appl. No.: 11/112,598

(22) Filed: Apr. 22, 2005

Related U.S. Application Data
(60) Provisional application No. 60/565,565, filed on Apr. 27, 2004.

(51) Int. Cl. F16L 35/00

(52) U.S. Cl. 277/616

(57) ABSTRACT

A pipe coupler interconnects pipes and fittings and sections of pipe end to end for transferring bulk dry and fluid materials. The coupler connects various pipe ends, grooved, smooth, and ground, together. The coupler also connects various fittings such as tees and valves to pipe ends. Two arms clamp upon the two pieces of a gasket to seal the connection of pipes and fittings within the coupler. A plurality of ridges upon both surfaces of the piece grasp and seal the end of a pipe. The gasket removes any gaps in the connection that would have trapped material and contaminated later loads of material.

### CROSS REFERENCE TO RELATED APPLICATION

This nonprovisional patent application claims priority to the provisional patent application having Ser. No. 60/565,565, which was filed on Apr. 27, 2005.

### BACKGROUND OF THE INVENTION

The gasket for a coupler upon a rail car, tank trailer, or related means relates to pipe couplers in general and more specifically to a coupler with a two piece gasket. Unique aspects of the present gasket for a rail car coupler are ends having grooves and tongues, and a pin for one way fitting of the gasket into an arm.

Designs of clamps and couplers that connect pipes or fittings end to end have been available in the art. The clamps regularly connect sections of pipe or hopper tees on railway tank cars, tank trailers, pipelines and other means for conveyance. In dry bulk hauling, such as pellets, powders, and grains, seal integrity at the pipe connection is essential to prevent contamination of the materials later hauled in a tank car. The pellets or powders unload from gravity gate valves or hoppers located on the bottom of a tank car. Tees attached to the bottom of a hopper connect with collection pipes. A vacuum or vibration created in the pipe accelerates the unloading of dry bulk products from a hopper. A hopper must be completely empty of a dry bulk product to prevent contamination with later loads. As an example, if a tank car carries black plastic resin beads, no trace of the black plastic resin beads can remain in the car, the hopper, and the piping to prevent contamination with a subsequent load of white resin beads. A second example shows the need for complete emptying of a product from the entire car: edible white flour. If the tank car or piping system traps the flour and mold develops, later loads of flour will acquire mold. A third example, bulk liquids contaminating bulk dry loads, can render a load useless at great cost in disposal and other losses.

The prior art has known that contamination occurs where a pipe couples to a hopper tee. Existing clamps have gasket seals that can trap product at a hopper tee. A prior art clamp has two semicircular sides connected by a hinge. A conventional lever with a cam tightens the two sides snugly to surround a joint, at pipe with a tee for example. A ring shaped gasket lines the interior of a clamp and deforms as the two sides tighten upon the joint. The typical gasket has outer walls and a center member that deform as they press against and seal a pipe joint. However, gaps arise between the sides and the center member. The gaps allow dry bulk product to collect. Product that lodges in a gap becomes difficult to remove. Further, a ring shaped gasket must be installed over an end of a pipe. That installation may prove difficult in the cramped quarters adjacent to a railway tank car.

The present art overcomes the limitations of the prior art. That is, in the art of the present invention, a gasket for a coupler upon a rail car, tank trailer, or related means has two pieces with a centering pin for ready installation.

### SUMMARY OF THE INVENTION

A coupler upon a rail car, tank trailer, or related means has a two piece gasket removably encased within two arms. The arms have a semicircular shape and pivot together at one end akin to a clamshell. The arms together define an annular opening to encircle the ends of pipes for connecting. A pivot joins the arms such as at a hinge. The first arm has a lever and an adjustable bail connected to the lever. The second arm has a boss to engage the bail when the second arm clamps about the gasket to the first arm. The arms each have a generally U shaped cross section defined by a bottom wall, and first and second opposed side walls. A piece of the gasket seats in a groove between the side walls. The pin of the gasket and the tapered edges center and seat the gasket in an arm. Tongues and grooves in each piece of gasket interlock as the first arm closes upon the second arm. The closing arms compress the gasket and deflect the center of the gasket as the coupler joins two pipe sections in a fluid and air tight seal. If a gasket leaks or becomes damaged, workers can remove a piece of the gasket from a coupler and replace the piece with the coupler remaining in position. In particular, the inner surface of the gasket pieces has raised ridges with a central ridge to seal the joint between pipes or between a pipe and a fitting. During installation of the coupler, the arms compress the gasket pieces around a pipe at the joint and spread the ridges to provide a greater sealing surface at the pipe joints. When compressed, the gasket pieces have no gaps or recesses to collect material that could contaminate a later load.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention

### BRIEF DESCRIPTION OF THE DRAWINGS

FIG. 1 shows an isometric exploded view of a gasket for a coupler upon a rail car, tank trailer or other bulk material transport with arms open in accordance with the principles of the present invention;

FIG. 1A shows a sectional view of an arm complementarily receiving a piece of a gasket of the present invention;

FIG. 2 shows an isometric view of the preferred embodiment of the gasket for a coupler installed to connect two pipes;

FIG. 2A shows a detail view of the gasket for a coupler under the load of two connected pipes;

FIG. 3 shows an isometric view of a piece of the gasket of the preferred embodiment of a gasket for a coupler constructed in accordance with the principles of the present invention;

FIG. 4 illustrates a side view of the present invention; and,

FIG. 5 illustrates a sectional view of the present invention through the alignment pin.

The same reference numerals refer to the same parts throughout the various figures.

### DESCRIPTION OF THE PREFERRED EMBODIMENT

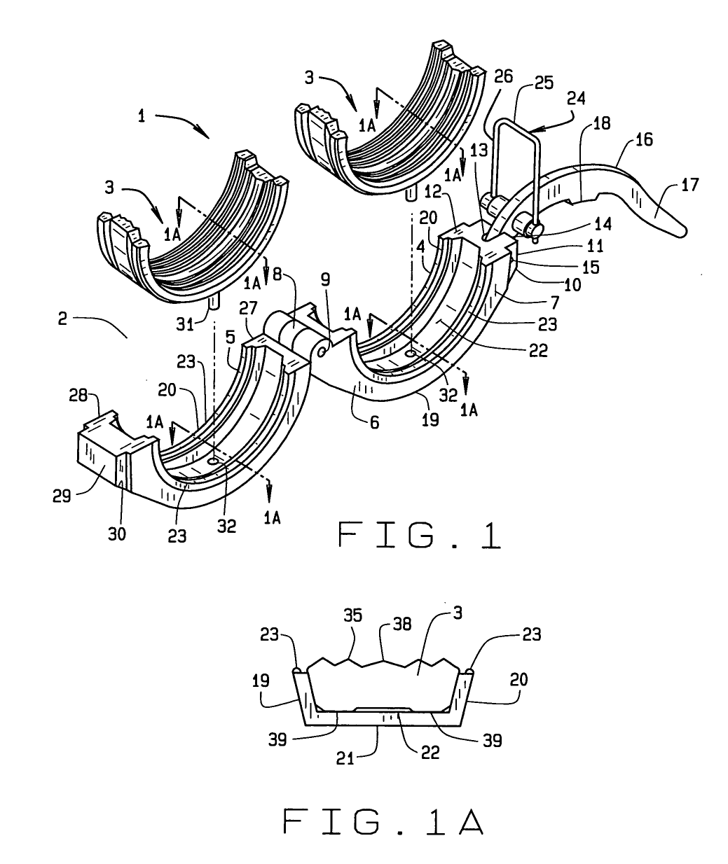

The present invention overcomes the prior art limitations by providing a two piece gasket having tongue and groove ends within a two arm coupler. The ends mate together to seal the coupler. Turning to FIG. 1, the preferred embodiment of the gasket 1 for a coupler 2 upon a rail car, tank trailer, or other related means is shown as two separate pieces 3 inserted into a coupler 2. The coupler 2 has a first arm 4 and a second arm 5 generally semi-circular in profile. The first arm 4 has a first end 6 and an opposite second end 7. The first end 6 has an integrally formed pivot 8 with a conventional hole and pin forming a hinge 9. The second end 7 has an integrally formed mount 10. The mount 10 has a first wall 11 and a second wall 12 with a gap 13 between them. A central hole 14 in the first wall 11 and a corresponding hole in the second wall 12 admit a pin to form a second hinge 15.

A lever 16 pivotally attaches to the mount 10 at the second hinge 15. The lever 16 has a generally arcuate shape and a handle 17 at one end and a hole (not shown) at the opposite end. A pin extends through the holes in the first and second walls 11, 12 and a pin extends through the hole in the opposite end of the lever 16. The interior curve of the lever 16 has an integral boss 18 that contacts the first arm 4 upon closing the coupler 2.

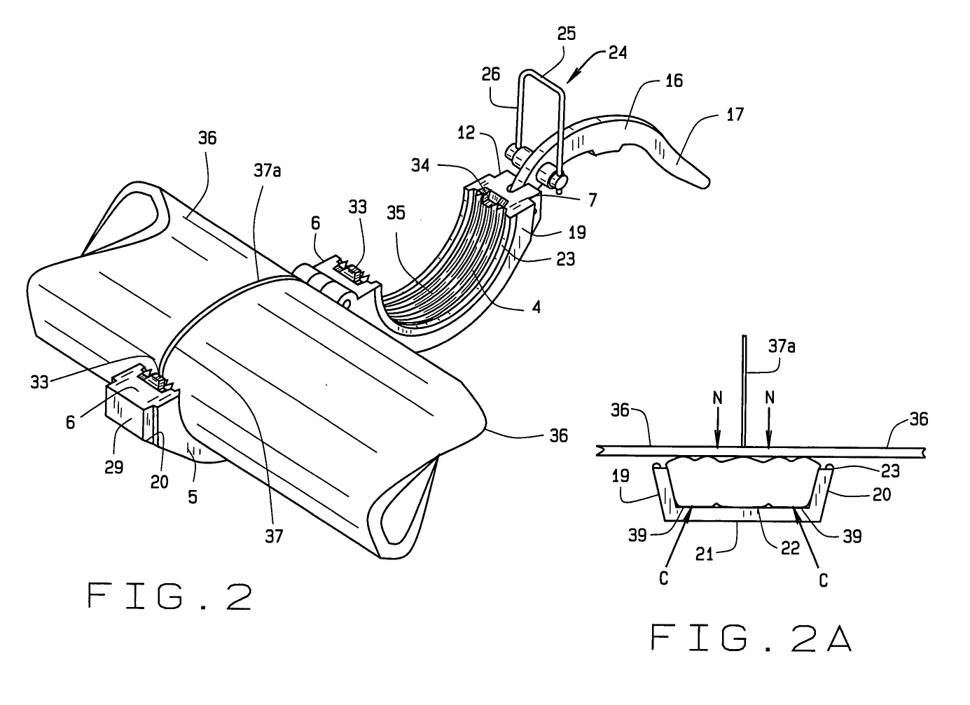

Referring briefly to FIG. 1A, an arm 4, 5 has a generally U shaped cross-section. The arm has a first sidewall 19, an opposite second sidewall 20, and a bottom wall 21 joining both the first sidewall 19 and the second sidewall 20. The first sidewall 19 and the second sidewall 20 extend outwardly from the bottom wall 21. Then, the first sidewall 19 and the second sidewall 20 have an integral raised rib 23 for the entire length of the sidewall 19, 20. In cooperation, the sidewalls 19, 20 define a groove 22 to receive a piece 3 of gasket 1. The piece 3 has a trapezoidal shaped cross section and seats in the groove 22 with a plurality of ridges 35, 38 located towards the wider base of the trapezoidal shape. At the narrower base of the trapezoidal shape, the piece 3 has a pair of ridges 39 upon the outer diameter. The ridges 39 have a generally rectangular cross section and extend partially across the width of the piece 3 with each ridge 39 upon an outer edge of a piece 3. Upon closing the coupler 1, the pieces 3 contact the pipe 36 as later described in FIG. 2 and the ridges 39 rest upon the groove 22.

Returning to FIG. 1, a bail assembly 24 pivotally attaches to the lever 16. The bail assembly 24 has a generally U shaped bail with a horizontal base 25 and vertical opposed arms 26. A rod (not shown) extends through a hole in the lever 16 and joins the arms 26 of the bail. The arms 26 of the bail and the rod have cooperating adjusting nuts. The bail assembly 24 allows adjusting the bail relative to the lever 16. Adjusting the bail assembly 24 maintains tension on the bail and an airtight fit of the arms 4, 5 as wear and tear afflicts the coupler 2 and gasket 1 over time.

Opposite the first arm 4, the second arm 5 has a first end 27 and a second end 28. A conventional pivot 8 on the first end 27 cooperates with the first hinge 9. The hinge 9 between the first and second arms 4,5 allows the first and second arms 4,5 to rotate relative to each other to open and to close the coupler 2 upon a pipe 36. The second end 28 of the second arm 5 has an integral boss 29. This boss 29 has a groove 30 that accepts the horizontal portion of the bail to close and to lock the arms 4, 5 together.

The gasket 1 has two pieces 3, one for each arm 4,5. A semi-circular piece 3 seats within the groove 22 of an arm 4,5 and takes position when an alignment pin 31 fits an alignment hole 32. The pieces 3 mate at their ends in a tongue 33 and groove 34 joint when the arms 4,5 close together to couple pipes 36. A piece 3 has a tongue 33 upon one end and a matching groove 34 upon the other end. Between the two ends, raised ridges 35 integrally occupy the inner surface 42 of a piece 3.

Turning to FIG. 2, the coupler 2 joins two pipes 36 or a pipe 36 and a fitting together. Each pipe 36 has an annular groove 37 incised in the ends of the respective pipe 36 sections. A piece 3 seats in the first and second arms 4,5 so that the groove 34 ends of the pieces 3 occupy the first ends 6,27 of the first and second arms 4,5. The raised ridges 35 of a piece 3 contact the ends of the pipes 36 to be joined and the central ridge 38 occupies the joint 37a of the pipes 36. The first and second arms 4,5 encircle the joint 37a of the pipes 36. The gasket 1 seats in the grooves 22 of the first and second arms 4,5. Closing the first arm 4 upon the second arm 5 brings together the tongue 33 and groove 34 ends of the pieces 3 to seal the pipes 36 in a fluid and an air tight joint 37a.

Viewing the pipe to pipe connection more closely, FIG. 2A shows the piece 3 of gasket with the coupler 2 closed upon connecting pipes 36. Upon closing, the coupler 2 generates a compressive force C upon the ends of the pipes 36. The pipes 36 respond with a reaction force N that compresses and flattens the ridges 35, 38 while deflecting the central portion of the piece 3 between the two outer ridges 39 towards the bottom wall 21. The ridges 35, 38 on the inner surface 42 in contact with the pipes 36 form the primary seal of the coupler 2. Deflecting of the piece 3 between the ridges 39 rotates the ridges 35 towards the pipes 36 and the central ridge 38 towards the groove 22. The ridges 39 on the outer surface 41 thus, form a secondary seal of the pipes 36.

Then in FIG. 3, a piece 3 of gasket 1 is made from a deformable, impervious material. Slightly oversized, a piece 3 has a semicircular body 40 with an outer surface 41 and an inner surface 42 with a thickness 43 of material in between. The outer surface 41 has two circumferential ridges 39 at the outer edges, each partially across the width of the piece 3. The ridges 39 have a generally rectangular cross section akin to a tabletop viewed on edge. Then, the inner surface 42 defines the internal bore that matches an appropriate pipe 36 diameter. The inner surface 42 has five symmetrical ridges 35,38. The central ridge 38 has greater width than the flanking ridges 35. The central ridge 38 receives the two pipe 36 sections at the joint 37a. Upon closing the coupler 2, the ridges 35, 38 deform, compress, and flatten to seal the joint 37a. Compressing and flattening a piece 3 in both the first arm 4 and the second arm 5 causes no gaps to arise in the joint 37a between two pipes 36. Further, compressing a piece 3 deflects the piece 3 beneath the central ridge 38 and between the ridges 39.

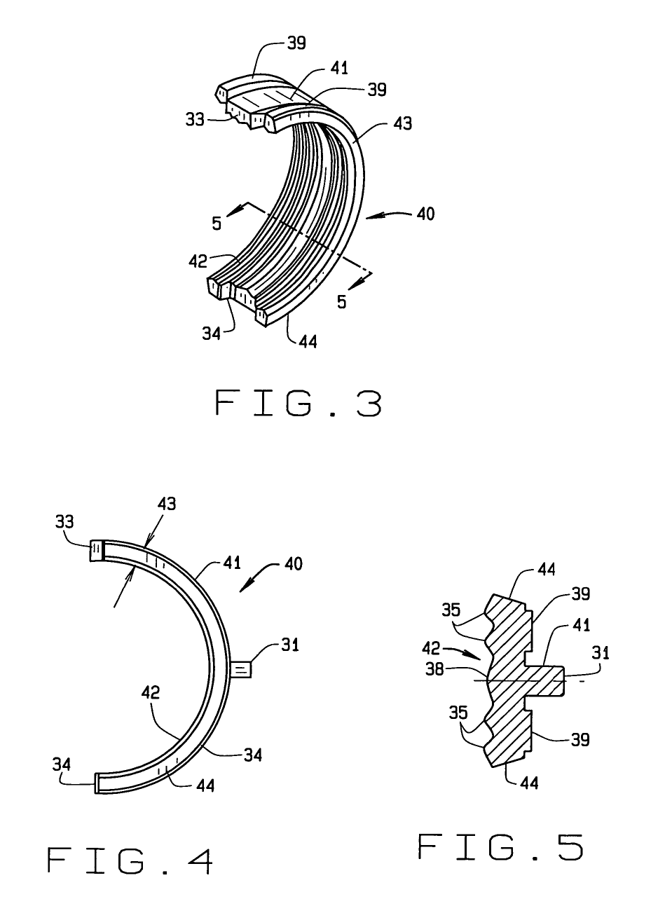

FIG. 4 shows a piece 3 of gasket 1 from the side. An end has an outwardly extending tongue 33 while the opposite end has a groove 34. The tongue 33 and groove 34 of one piece 3 form a complementary joint with the tongue 33 and groove 34 of a second piece 3. Generally midway upon the circumference of a piece 3, an alignment pin 31 extends perpendicular from the outer surface 41. This location of the alignment pin 31 permits installation of a piece 3 in two positions and possible mis-fitting of two tongues 33. The alignment pin 31 has a shape to fit the alignment hole 32 in the first arm 4 and the second arm 5. In the preferred embodiment, the alignment pin 31 has a round shape. Alternatively, the alignment pin 31 has a square shape. Alternatively, the alignment pin 31 is located off center to restrict installation of a piece 3 to one position and to provide precise fitting of a tongue 33 with a groove 34. From one end to the other end of the piece 3, a tapered edge 44 proceeds from the inner surface 42 to the narrower outer surface 41.

Turning to FIG. 5, at the alignment pin 31, the piece 3 of gasket 1 has five ridges: a central ridge 38 and four flanking ridges 35 arranged symmetrically. The ridges 35, 38 have a triangular cross section. The central ridge 38 has greater width than a flanking ridge 35 and is located upon the inner surface 42 opposite the alignment pin 31. The central ridge 38 fills the gap between two sections of pipe 36 at a joint 37a. The flanking ridges 35 have less width than the central ridge 38 and fill the gap 13 between a pipe 36 and an arm 4,5. The alignment pin 31 extends opposite the central ridge 38 and away from the piece 3. Upon the outer surface 41 and flanking the alignment pin 31, the piece 3 has two ridges 39. The ridges 39 have a generally rectangular cross section. Extending partially across the width of the piece 3 and spanning two other ridges 35, these ridges 39 occupy the circumference of the piece 3. Pressure upon the central ridge 38 deflects the piece 3 between the ridges 39 towards the alignment pin 31. The deflection provides a secondary seal of the pipes 36.

In use, a worker places a piece 3 of gasket 1 in each arm of the coupler 2, positions the alignment pins 31 in the alignment holes 32 of the arms 4,5 and the tongue 33 ends towards the first ends 6, 27 of the arms 4,5, seats the gaskets 1, positions the coupler 2 upon the pipes 36, then closes the first arm 4 upon the second arm 5 and secures the bail assembly 24 to lock the coupler 2.

From the aforementioned description, a gasket for a coupler upon a rail car, tank trailer, or related means has been described. The gasket for a coupler is uniquely capable of aligning two gasket pieces within the coupler and interlocking the ends of the pieces in an airtight seal. The gasket for a coupler and its various components may be manufactured from many materials including but not limited to acrylonitrile, polymers, silicone, high density polyethylene HDPE, polypropylene PP, polyethylene terephalate ethylene PETE, polyvinyl chloride PVC, nylon, and composites.

The phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

1. A gasket for seating in an adjustable pipe coupler to seal tightly two axially aligned abutting pipe sections, when the adjustable pipe coupler incorporating clamping arms closes upon the pipe sections, the gasket comprising:
two semi-circular pieces, said pieces having a first end and an opposite second end, an outer surface and an inner surface spanning between said first end and said second end, said inner surface defining a bore, with a material thickness between said outer surface and said inner surface, said pieces dimensioned so that said outer surface seats in a groove in said clamping arms;
said outer surface having an outwardly perpendicular centered alignment pin;
said first end having an outwardly extending tongue partially across the width of said first end and said second end having an inwardly extending groove of similar shape as said tongue whereby the tongue of one piece forms a fluid and airtight joint with the groove of a second piece; and,
said inner surface having raised areas that provide a plurality of inwardly extending uniformly spaced ridges upon said inner surface, said ridges being symmetrically formed as triangular in cross section and being uniformly spaced apart from each other, and said ridges disposed for compressing against the pipe surfaces when the coupler is closed.

2. The gasket of claim 1 further comprising said inner surface having at least three ridges, a centrally arranged ridge and at least two outer disposed ridges, the central ridge positioned to compress and to spread against a pipe joint formed by two abutting sections of pipe, and the two outer ridges disposed for compressing against the pipe surfaces when the coupler is closed.

3. The gasket of claim 1 wherein said alignment pin is round in cross section.

4. The gasket of claim 1 wherein said alignment pin is square in cross section.

5. The gasket of claim 1 wherein said tongue has a trapezoidal shape with the wide base at said first end and said groove has a matching trapezoidal shape to receive said tongue.

6. The gasket of claim 2 further comprising said outer surface having a pair of ridges spaced apart, extending partially across said piece, and symmetrically disposed upon the circumference of said piece.

7. The gasket of claim 6 wherein said ridges have a generally rectangular cross section
